(19) United States
(12) Patent Application Publication
(10) Pub. No.: US 2008/0310911 A1
(43) Pub. Date: Dec. 18, 2008

(54) Track Connecting Assembly

(75) Inventors: Mark Jones, Warrington (GB); Gregory David Roughley, Merseyside (GB)

Correspondence Address: BARLOW, JOSEPHS & HOLMES, LTD., 101 DYER STREET, 5TH FLOOR, PROVIDENCE, RI, 02903, US

(73) Assignee: CONDUCTIX LIMITED, SALFORD (GB)

(21) Appl. No.: 12/096,919

(22) PCT Filed: Dec. 12, 2006
(86) PCT No.: PCT/GB2006/004617

§ 371 Date: Aug. 22, 2008

(30) Foreign Application Priority Data
Dec. 15, 2005 (GB) 0525473.5

(51) Int. Cl. F16B 7/00

(52) U.S. Cl. 403/309

(57) ABSTRACT

A. track assembly includes two or more track sections (10, 11) the ends of which are inserted into a connecting sleeve (1). The shapes of the track sections and connecting sleeve match to enable easy sliding insertion, and they feature a continuous longitudinal slot (2, 12) in both the track sections and the connector sleeve to receive a guided element. The ends of the track sections are formed with a slot (15) and stop (17), and holes (7, 8) are provided symmetrically of a centre position (9) of the sleeve. Tines (21, 22) of a clip (20) are inserted through holes (7, 8) and engage in slots (15), to hold the ends of the track sections in place, and the clip (20) is retained by a resilient tongue (23) which engages the top of the sleeve.

The present invention relates to a track connecting assembly which is particularly suitable for connecting together tracks, rails, poles and the like which form part of a modular system.

Previously, track and rail sections, in particular c-rail sections, have been connected together by way of a sleeve into which respective ends of two track sections are inserted. In order to hold the sleeve in place and therefore, the rail sections together such that their respective ends are in abutment, screws which pass through the sleeve are tightened against an outer surface of the rail sections forcing the rail sections up against an internal surface of said sleeve.

The above referenced system relies upon the installer to achieve a good connection with the screw and the rail. Furthermore, this method of connection can cause rail damage as a result of over tightening of the screw(s). Therefore, this system is plagued with difficulties.

As a consequence of these difficulties an alternative system was developed. The alternative system comprises a sleeve which is positioned over the respective ends of two rail sections to be connected together. The respective ends of the rail are inserted into either end of the sleeve and a tang located on the internal surface of the upper wall of the sleeve fits into a T-shaped aperture located in the upper surface of each rail section such that the two rail sections are held together. However, this system gives rise to space between the outer surfaces of the rail section and the inner surfaces of the sleeve such that the rail is capable of vertical movement within the sleeve. In order to address this and to ensure that said tang enters said aperture, a key having undulating arms is inserted into said aperture to make the joint area rigid and minimise the vertical movement. In this case, the arms of the key extend the entire length of the connecting sleeve.

Although effective, the joints connected via this method are difficult to disassemble for routine maintenance since upon removal of the key the securing tang tends to remain in the aperture.

Therefore, an object of the present invention is to provide a releasable connecting assembly suitable for use with rails and tracks which provides a secure and rigid joint for rails and tracks without the need for space filling elements along the whole length of the sleeve and which can be quickly and easily disassembled.

According to the present invention there is provided a track assembly comprising at least two track sections and at least one connector sleeve, to facilitate end-to-end connection of any two of the track sections, the connector sleeve having an open end at each end to receive ends of the respective track sections, characterised in that each track section has detent means adjacent its end to be received in the connector sleeve, the sleeve having at least two apertures for insertion of engagement members to engage with said detent means, and a clip member having tine members providing said engagement members, and a resilient member engaging externally with the sleeve to retain the clip when inserted.

With this arrangement the assembly of the present invention provides a strong and rigid joint for connecting the track sections.

Furthermore, the assembly of the present invention can be easily disassembled by simply removing the clip member. This facilitates routine maintenance and repair of any modular system of which the assembly forms part.

A still further advantage of the present invention is that the assembly can be constructed with minimal tooling. That is few, if any, tools are required unlike the prior art connecting systems which utilise screws.

The connecting sleeve of the present invention may be of any suitable cross-sectional shape. Preferably, the cross-sectional shape of the sleeve is such that the inner surface of the sleeve substantially matches that of the outer surface of the elongate members to be inserted therein. With this arrangement little, if any, space exists between said inner and outer surfaces.

The sleeve is preferably a hollow open ended structure defined by an outer wall. The outer wall may be such as to form a closed sleeve structure, or it may comprise a gap or slot extending in a longitudinal direction so as to form a discontinuous sleeve.

The sleeve may also comprise an indentation in its outer wall which extends in a longitudinal direction. The indention may extend throughout the length of the sleeve or any part thereof.

Alternatively, the sleeve may comprise a raised ridge portion which may extend throughout the length of the sleeve or any part thereof. In any event, the connecting sleeve is configured such that when at least one elongate member is inserted therein a rigid arrangement is provided.

The sleeve may be straight, curved, U-shaped, right-angled, cross, or T-shaped. With this arrangement various orientations for a modular system comprising elongate members such as those of the present invention can be provided.

Preferably the sleeve comprises two or more apertures with which to receive the locking means. The apertures are arranged longitudinally with respect to the sleeve and are located symmetrically with respect to the central point of the sleeve longitudinally of the sleeve.

More particularly each side wall of the sleeve comprises two or more apertures, the apertures on each side wall being positioned opposite each other.

The apertures may be of any suitable shape for receiving the locking means.

The track members according to the present invention can be hollow for at least part of their length.

The track members may each be provided with an end region which is hollow or said members may be hollow throughout their length.

In either case, the hollow portion of the track member may be defined by an outer wall. The outer wall may be such as to form a closed structure or it may comprise a gap or slot extending in a longitudinal direction so as to form a discontinuous structure

The track member preferably comprises one or more raised ridge portion extending in a longitudinal direction. The ridge may extend throughout the length of the elongate member or any part thereof.

With this arrangement, when assembled, the ridge of the track member cooperates with the inner surface of the connecting sleeve thereby creating a rigid assembly.

The means for facilitating the retention of the elongate member may also comprise a stop consisting of a raised portion at the terminus of the member, said stop being located on the outer surface of the member.

With this arrangement the locking means engages the trailing edge of the raised portion, relative to the direction of insertion of the member into the sleeve, such that the elongate member is retained in position within the sleeve

Preferably, the means for facilitating the retention of the elongate member comprises a slot located in the ridge portion of the elongate member. The slot is positioned close to the leading edge of the elongate member such that said slot aligns with at least one of the apertures in the side wall of the connective sleeve.

The slot may be of any suitable shape, for example T-shaped, or cross-shaped but it is preferably rectangular.

The releasable locking means preferably comprises a snap fit clip. The clip preferably comprises at least two tines and an upper resilient member. The said members are connected together by way of a bridging portion. Preferably the clip comprises two or more tines arranged parallel to each other. The tines may be formed from suitably shaped flat strips. In any event the number of lower members corresponds to the number of apertures in the connecting sleeve which receive said lower members. One of the tines may be longer than the other.

The upper member is a resilient member which once in position in the assembly of the present invention communicates with the outer surface of the connecting sleeve. The resilient nature of the clip prevents the clip from simply falling out of the assembly.

The upper member of the clip is preferably shaped so as to follow the contour of the outer surface of the connecting sleeve with which it communicates. For example, it may be substantially S-shaped or it may be flat inprofile.

The present invention also provides a method of releasably connecting together two elongate members.

Therefore, according to a second aspect of the present invention there is provided a method for connecting two or more track members, comprising inserting one end region of each of two track members into a connecting sleeve characterised in that the track members are retained by means of a releasable locking device which has at least one tine to engage with a detent means in each track member through respective holes in the sleeve member, and a resilient member to retain the locking device in position.

It is envisaged that the present invention will find utility in overhead crane systems, festooning cables, curtain doors in factories and tent poles for example.

The present invention will now be described by way of example only with reference to the following drawings, in which:

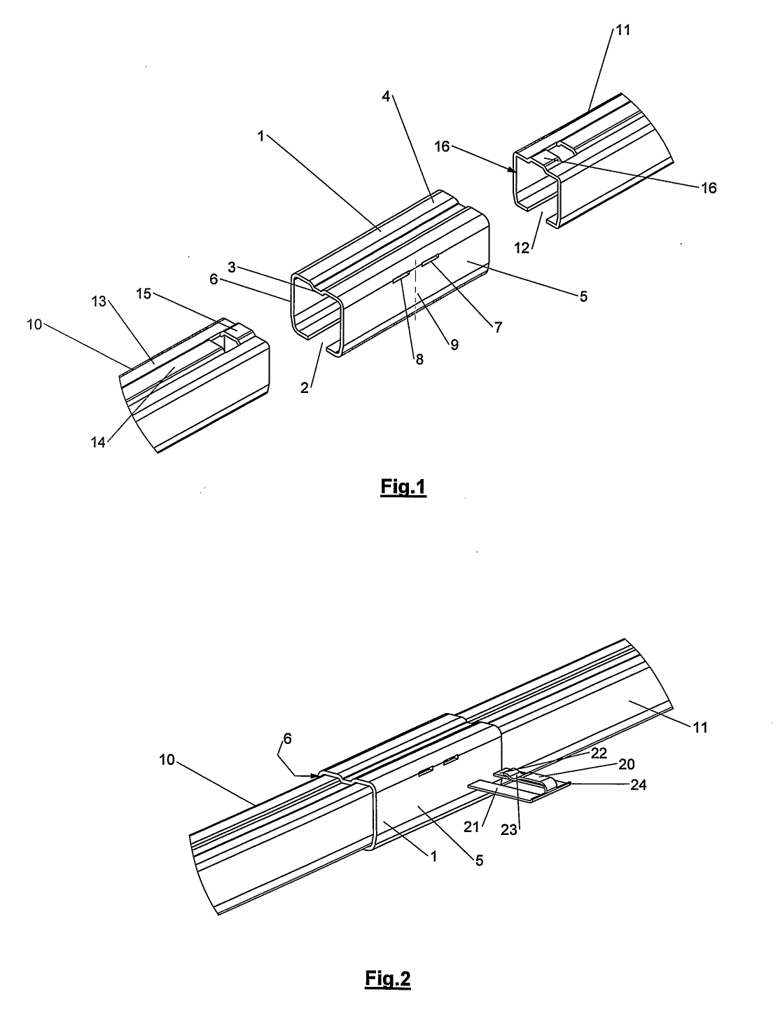

FIG. 1 is a perspective view of a connecting sleeve and two respective track sections in accordance with the present invention;

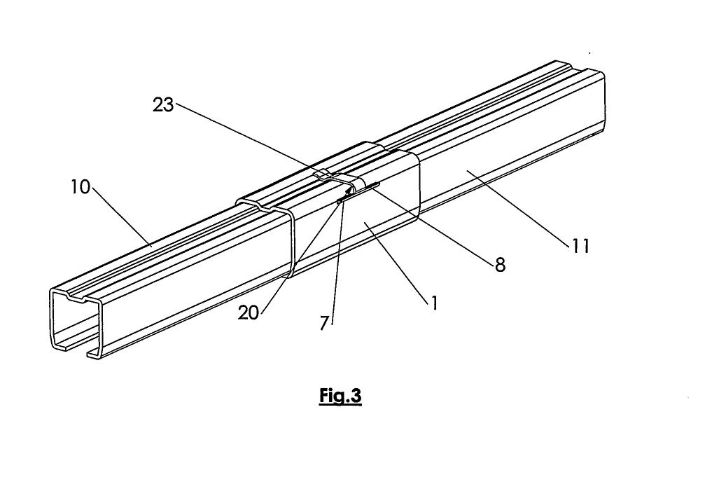

FIG. 2 is a perspective view of the connecting sleeve and track sections of FIG. 1 in a partly assembled configuration together with a clip in accordance with the present invention;

FIG. 3 is a perspective view of the connecting sleeve, tracks sections and clip of FIG. 2 in an assembled configuration in accordance with the present invention;

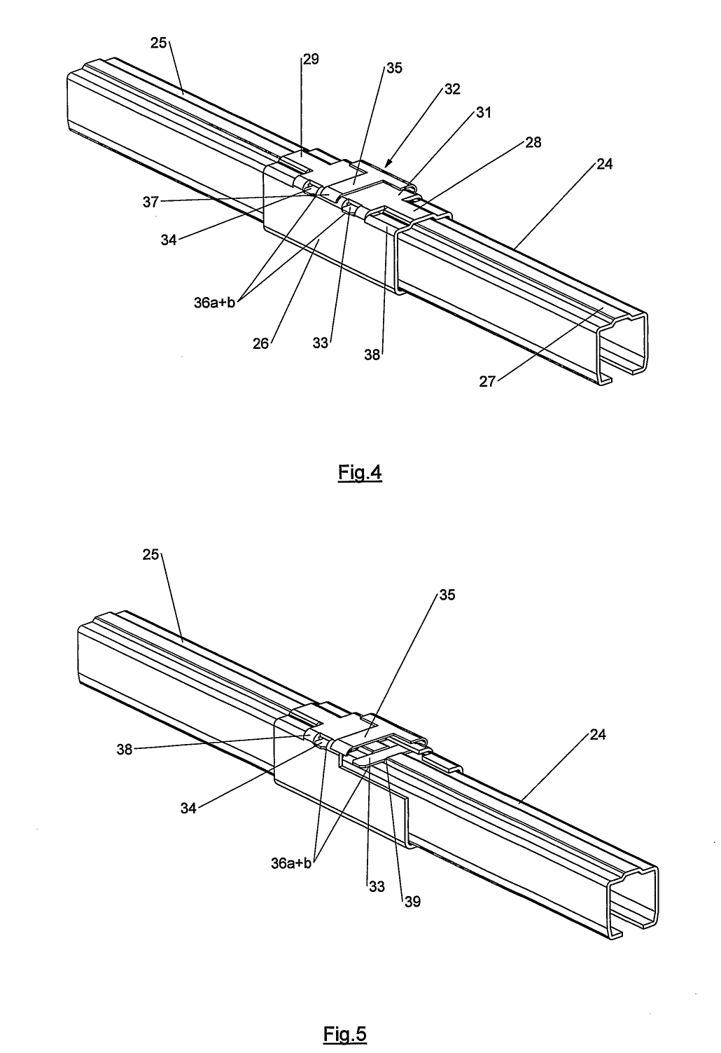

FIG. 4 is a perspective view of an alternative embodiment of an assembled configuration in accordance with the present invention;

FIG. 5 is a perspective view of an assembled configuration of FIG. 4, wherein part of a connecting sleeve is cut away to show a clip in position;

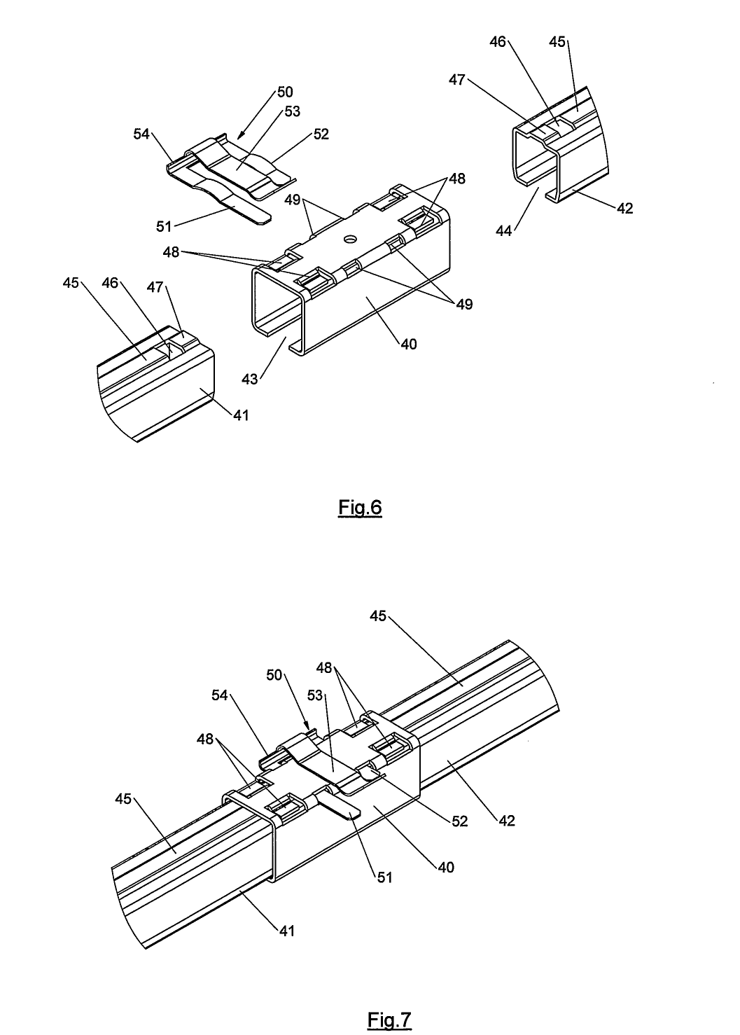

FIG. 6 is a perspective view of a further embodiment of an assembly in accordance with the invention in ‘exploded’ state; and

FIG. 7 shows the same embodiment, assembled.

FIG. 1 shows a connecting sleeve 1 in the form of a hollow member having a substantially c-shaped cross-section. The connecting sleeve 1 has a lower opening which is in the form of a slot 2 extending in the longitudinal direction of the connecting sleeve. The connecting sleeve 1 also has an indentation 3 in its upper surface 4 extending in the longitudinal direction of the connecting sleeve 1. The indentation 3 is located directly opposite the slot 2. One of the side walls 5 and 6 of the connecting sleeve 1 is provided with two apertures 7 and 8. Each aperture 7 and 8 is positioned at an equal distance from the longitudinal central point 9 of the connecting sleeve 1.

FIG. 1 also shows two identical elongate members, in this case, track sections 10 and 11 in the form of hollow members having a c-shaped cross-section. Each track section is provided with a lower opening in the form of a slot 12 extending in the longitudinal direction of the section. The upper surface 13 of each track section is provided with a raised ridge 14 extending in the longitudinal direction of the track section. The ridge 14 is centrally located in the transverse direction of the section and is located directly opposite the slot 12.

Towards the end of each track section the ridge 14 is provided with a slot 15. The slot is separated from the terminus 16 of the track section by way of a stop 17 formed from the ridge 14.

FIG. 2 shows each track section 10 and 11 positioned inside the connecting sleeve 1 such that the termini of each track section are in abutment (not shown). Once positioned inside the connecting sleeve 1 the outer surfaces of the side walls 5 and 6 of the track section 10 and 11 cooperate with the inner surfaces of the connecting sleeve 1. Likewise, the outer surface of the ridge 14 of the track section cooperates with the inner surface of longitudinal indentation 3 of the connecting sleeve 1. In order to secure the track sections together a clip 20 is required. The clip has two lower members or tines and an upper resilient member 23 which is substantially S shaped. The tines and the upper resilient member are connected by way of a bridging portion 24.

FIG. 3 shows the two track sections 10 and 11 located inside the connecting sleeve 1. Each aperture 7 and 8 located in the side wall of the connecting sleeve receives a lower arm or tine 21 and 22 of the clip 20. Each lower member of the clip extends laterally through the connecting sleeve 1 engaging with the slot 15 of one of the track sections 10 and 11. The upper resilient member of the clip bears down on the upper outer surface of the connecting sleeve 1.

FIG. 4 shows two sections of track 24 and 25 positioned inside a connecting sleeve 26. Each side wall of the connecting sleeve 26 comprises two sets of two apertures, (only one set of the two is visible). Each track section is provided with a raised ridge portion 27 which extends longitudinally. The connecting sleeve 26 also has a raised section 28 and 29 at each end which follows the contour of the track section. The upper surface 30 of the connecting sleeve has a second raised section 31 which unlike the first raised section extends the width of the connecting sleeve 26.

A clip 32 comprising two tines 33 and 34 and an upper resilient member 35 is used to secure the assembly. Each lower arm of the clip is inserted into one aperture of a set of apertures such that the arms extend laterally through the connecting sleeve 26 and protrude through the oppositely positioned set of apertures 36. The resilient member 35 is shaped so as to cooperate with the contour of the connecting sleeve 26. In this case it is a substantially flat member. The resilient member 35 is provided with a curved terminus 37 which engages with the corner edge 38 of the connecting sleeve so as to prevent the clip from simply falling out of position.

FIG. 5 shows two sections of track 24 and 25 positioned inside a connecting sleeve 26. Each aperture located in one of the side walls (not shown) of the connecting sleeve 26 receives a lower arm or tine 33 and 34 of a clip 32. Each tine 33 and 34 of the clip 32 extends laterally through the connecting sleeve 26 engaging with slots 37 and 40 (only one is visible) of the track sections 24 and 25. Each tine extends through the connecting sleeve 26 so as to protrude through apertures 36a and 36b located on the opposite side of the connecting sleeve 26. The clip 32 is secured in place by its resilient member 35 whose shape corresponds to the contour of the connecting sleeve. The resilient member 35 is provided with a curved terminus 37 which hooks over the corner edge 38 of the connecting sleeve.

FIGS. 6 and 7 show a further embodiment of track assembly and connector according to the invention, comprising a connector sleeve 40, and first and second track sections 41, 42. The sleeve 40, and track sections 41, 42 are hollow, and generally c-shaped in cross-section having respective longitudinally extending slots 43, 44 along their sides, so that each part comprises a channel section member having inwardly turned flanges.

Each track section 41, 42 is formed with a raised part 45 extending longitudinally along the centre line thereof along the upper side of the track section. The track sections 41, 42 are each formed at each end with a slot 46 formed in the respective raised part 45, which is separated from the end of the section by a strip 47.

The connector sleeve 40 is provided towards each end with recessed tabs 48 which engage with the upper surface of the respective track sections end to either side of the central raise part 45. The sleeve 40 also has a pair of apertures 49 in each side at the top thereof, disposed equidistant from the mid-length plane of the sleeve. Also provided is a connector clip 50, which comprises a longer prong 51 and a shorter prong 52, and an upper resilient tongue 53, the latter being connected to the prongs 51, 52 by an angled connecting piece 54.

The assembly is achieved by inserting the ends of the track members end to end into the connector sleeve 40, till they meet at the central plane of the latter. The clip 50 is then inserted by pushing the prongs 51, 52 into the apertures 49, which are aligned with the slots 46 in the ends of the track sections, and the tongue pushed over the outer face of the top side of the connector. This is shown in FIG. 6, which also shows that the longer prong 51 extends substantially from the opposite side of the connector sleeve.

In use, a first track section 10 and a second track section 11 are inserted into respective ends of the connecting sleeve such that the one terminus of a first track section member is in abutment with the terminus of a second track section member. In order to retain the first and second track section members in position a snap fitting clip 20 is used. Each aperture 7 and 8 located in the side wall 5 of the connecting sleeve 1 receives a tine 21 and 22 of said clip. Each lower member passes through the aperture in a lateral manner and extends through the connecting sleeve 1. In doing so each lower member engages with the slot 20 in the ridge 4 of each respective track section member. Due to the communication of the upper outer surface of the ridge of the track section member and lower internal surface of the longitudinal indentation of the connection sleeve 1 each lower arm member effectively forms a pin extending laterally across the connecting sleeve thereby preventing the track sections from being parted in a longitudinal direction. The upper resilient member of the clip communicates with the outer upper surface of the connecting sleeve thereby preventing the clip from falling out of position.

It is of course to be understood that the invention is not intended to be restricted to the details of the above embodiments which are described by way of example only.

1. A track assembly comprising at least two track sections (10, 11), and at least one connector sleeve (1) to facilitate end-to-end connection of any two of the track sections, the connector sleeve (1) having an open end at each end to receive ends of the respective track sections (10, 11) characterised in that each track section (10, 11) has detent means (15, 17) adjacent its end to be received in the connector sleeve (1), the sleeve having at least two apertures (7, 8) for insertion of engagement members to engage with said detent means (15), and a clip member (20) having tine members (21, 22) providing said engagement members, and a resilient member (23) engaging externally with the sleeve to retain the clip when inserted.

2. A track assembly according to claim 1, characterised in that the connecting sleeve (1) has an internal cross-sectional shape which matches the external cross section of the outer surface of the track sections (10, 11).

3. A track assembly according to claim 1 characterised in that the sleeve (1) is a hollow open ended structure defined by an outer wall, said wall being such as to form a sleeve structure formed with a longitudinal slot (2) which matches in position and width a longitudinal slot (12) in each of the track sections.

4. A track assembly according to claim 1 wherein the sleeve (1) has an indentation (3) in its outer wall which extends longitudinally of the sleeve.

5. A track assembly according to claim 1 wherein the sleeve (24) is provided with a raised ridge (14) which extends throughout the length of the sleeve or any part thereof.

6. A track assembly according to claim 1, wherein the sleeve is straight, curved, u-shaped, right-angled, cross, or t-shaped.

7. A track assembly according to claim 1 wherein the apertures (7, 8) in the sleeve wall, are arranged longitudinally with respect to the sleeve, and are located symmetrically with respect to the central point of the sleeve, longitudinally of the sleeve.

8. A track assembly according to claim 7 wherein the apertures (J, 8) comprise aligned apertures in opposed side walls (5, 6) of the sleeve.

9. A track assembly according to claim 1, wherein the track members (10, 11) are each provided with an end region which is hollow, or are hollow throughout their length.

10. A track assembly according to claim 9, wherein each track member (10, 11) is defined by an outer wall which is provided with a gap or slot (12) extending longitudinally therealong, and matching the slot (2) in the sleeve (1).

11. A track assembly according to claim 10, wherein each track member comprises one or more raised ridge portions (14) extending longitudinally thereof.

12. A track assembly according to claim 1, wherein the respective engagement member (15) of each end of each track member comprises a slot formed in an upper part of the track member, and a stop consisting of a raised portion (17) at the terminus of the track member.

13. A track assembly according to claim 1 wherein the clip member (20) constitutes a releasable locking means and provides a snap fit clip comprising two or more tine members (21, 22) one for each aperture (7, 8) and at least one for each track member, and the resilient member (23) which is adapted to resiliently engage the side of the sleeve member (10) opposed to the slot (2).

14. A track assembly according to claim 13 wherein the tine members are disposed parallel to each other.

15. A track assembly according to claim 13 wherein the tine members are formed from suitably configured flat strips.

16. A track assembly according to claim 13 wherein one of the tine members is longer than the other or others.

17. A method for releasably connecting two or more track members (10, 11) in a track assembly comprising inserting one end region of each of two track members (10, 11) into a connecting sleeve (1), characterised in that the track members (10, 11) are retained by means of a releasable locking device (20) which has at least one tine to engage with a detent means (15) in each track member, through respective holes (J, 8) in the sleeve member (1), and a resilient member (23) to retain the locking device in position.

18. A track assembly which comprises two or more track sections (10, 11) the ends of which are inserted into a connecting sleeve (1), the shapes of the track sections and connecting sleeve matching to enable easy sliding insertion, characterised in that the ends of the track sections are formed with a slot (15) and stop (17), and holes (7, 8) are provided symmetrically of a centre position (9) of the sleeve (1) and in that tines (21, 22) of a clip (20) are inserted through said holes (J, 8) and engage in the slots (15) to hold the ends of the track sections (10, 11) in place, and the clip (20) is retained by a resilient tongue (23) which engages a surface of the sleeve (1).

19. A track assembly according to claim 18, wherein the track sections and sleeve are all provided with a longitudinal slot for reception of a guided element.
